(19) United States
(12) Patent Application Publication
(10) Pub. No.: US 2010/0191578 A1
(43) Pub. Date: Jul. 29, 2010

(54) SYSTEMS AND METHODS FOR PROVIDING ENHANCED ACCESS TO HIGH FASHION USING A PORTABLE ELECTRONIC DEVICE

(75) Inventors: Monica Tran, Hayward, CA (US); Christine Kim Cho, Cupertino, CA (US); Stanley Carl Ng, Los Altos, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/579,756

(22) Filed: Oct. 15, 2009

Related U.S. Application Data
(60) Provisional application No. 61/147,654, filed on Jan. 27, 2009.

(51) Int. Cl. G06Q 30/00; G06Q 50/00; G06Q 10/00; H04M 1/00

(52) U.S. Cl. 705/10; 705/27; 705/14.25; 705/14.23; 705/14.19; 455/556.1

(57) ABSTRACT

This is directed to systems and methods for enhancing a user's experience when shopping for high fashion items. In some embodiments, an integrated application available on an electronic device can provide information for promotional and invitation-only events, allow a user to browse and search through fashion items, recommend fashion items to purchase based on outfits desired by the user, check for the availability of particular fashion items, and view or providing ratings or reviews for stores or fashion items.

### CROSS-REFERENCE TO RELATED APPLICATIONS

This application claims the benefit of U.S. Provisional Patent Application No. 61/147,654, filed on Jan. 27, 2009, which is hereby incorporated by reference herein in its entirety.

### FIELD OF THE DISCLOSURE

This is directed to providing enhanced access to high fashion and to providing advice and purchase opportunities in high fashion using a portable electronic device.

### BACKGROUND OF THE DISCLOSURE

Many buyers of high fashion desire to educate themselves prior to purchasing fashion items. In particular, buyers can wish to review what different merchants offer, compare the offered merchandise with what buyers already own, and review the latest trends. In addition, some buyers can wish to identify sales and availability of merchandise before going to a store to shop. To do so, buyers may need to purchase and read several fashion magazines, call or visit different stores to ascertain the availability of different items, and perform research using different sources (e.g., the Internet or other sources).

While all of the resources a buyer may need to most effectively shop may be available, the resources may not be centralized or easily accessed from a single location. In addition, some resources may not be available over the same types of communications links. For example, some resources may only be available over the telephone, such as information regarding the specific availability of merchandise in particular stores. As another example, some information may only be available from a combination of resources (e.g., a buyer may be required to access different sources associated with different sellers). From a user's perspective, this lack of centralization of interactions with the fashion provider can require more effort from the user wishing to take advantage of shopping resources than they wish to give, and perhaps even dissuade the user from shopping with the fashion provider (thus at a cost to the fashion provider).

### SUMMARY OF THE DISCLOSURE

This is directed to system and methods for providing enhanced access to high fashion services in accordance with some embodiments of the invention. In particular, this is directed to providing enhanced access to high fashion through an integrated application of an electronic device.

For example, the electronic device may include an integrated application operative to interface with one or more fashion provider systems to provide access to different services and different information available from the fashion providers. For example, the integrated application can connect to servers available from one or more stores or high fashion providers to receive data reflecting their latest collections. As another example, the integrated application can receive recommendations from fashion providers regarding recommended combinations of merchandise to form outfits.

In some embodiments, the integrated application can provide functions to attract or entice a user to view a particular fashion provider. For example, through the integrated application, a user can be provided with promotions and invitations to special events, access product availability, access a store locator, and be provided with opportunities to pre-order and reserve fashion items. In some embodiments, the integrated application can provide enhanced fashion item information to a user. For example, a user may scan an advertisement including a barcode, embedded pixel pattern, or other information-including pattern with an electronic device. By doing so, the user can access enhanced information associated with the fashion item of the advertisement. As another example, social networking features can be provided by allowing a user to create wish lists, look books, gift guides, or other collections of fashion items. These collections may then be provided to a social website or otherwise shared such that friends and acquaintances can provide feedback on the collections.

In some embodiments, the integrated application can provide a user with sales assistance (e.g., while the user is in a store of the fashion provider). For example, fashion items in the store may include an optical pattern (e.g., a barcode) on their price tag. A use may then scan the optical pattern to obtain additional information or features associated with that fashion item. For example, the optical pattern may be scanned by taking a digital image of the price tag with a camera of the user's electronic device. By analyzing the digital image of the optical pattern, the integrated application may access information associated with the fashion item such as ratings, availability (e.g., in a particular size, color, style, or the like), comparisons (e.g., price comparisons of the same or similar items from other fashion providers or other store locations), outfit recommendations, and other suitable features.

In some embodiments, the integrated application can provide a user with up-selling and cross-selling opportunities. For example, the integrated application may access a database of fashion items currently owned by the user. Based on that database, the integrated application may locate fashion items available for purchase from one or more fashion providers that can be matched with the user's currently owned fashion items to produce an outfit. These matching fashion items may then be recommended to the user for purchasing.

In some embodiments, the integrated application can provide a user with post-purchase opportunities. For example, the user can be provided with opportunities to rate and review a store, a fashion provider, a fashion item, or any combination of the above. As another example, an interface can be providing allowing a user to mix-and-match currently purchased fashion items to build outfits. As another example, using historical data to identify buying trends of a particular user, fashion providers can deliver personalized notifications directly to the user's electronic device.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative electronic device for providing enhanced access to high fashion in accordance with some embodiments of the invention;

FIG. 2 is a schematic view of several situations during which a user can make use of a single, integrated application in the context of the fashion industry in accordance with some embodiments of the invention;

FIG. 3 is a schematic diagram of advantages of an integrated application for enhancing a user's fashion industry experience in accordance with some embodiments of the invention;

FIG. 4 is a schematic view of functions for attracting a user to view a fashion provider in accordance with some embodiments of the invention;

FIG. 5 is a schematic view of functions available to a user for browsing a store to provide enhanced information in accordance with some embodiments of the invention;

FIG. 6 is a schematic view of in-store sales assistance functions available to a user in accordance with some embodiments of the invention;

FIG. 7 is a schematic view of functions available to a user for up-selling and cross-selling in accordance with some embodiments of the invention;

FIGS. 8A and 8B are schematic views of functions available to a user after purchasing a fashion item in accordance with some embodiments of the invention; and

FIG. 9 is an illustrative process for providing a complete fashion experience to a user in accordance with some embodiments of the invention.

### DETAILED DESCRIPTION

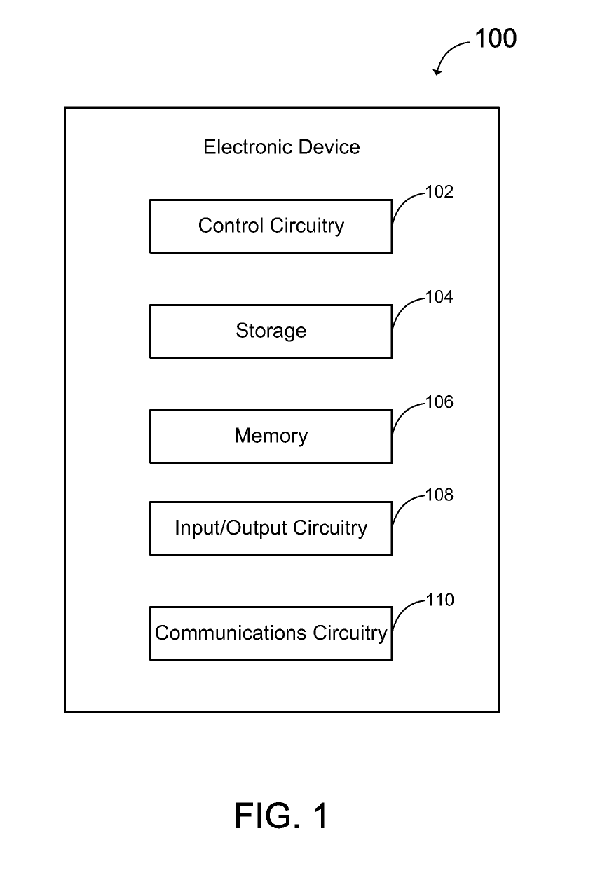

FIG. 1 is a schematic view of an illustrative electronic device for providing an application operative to interface with a fashion provider system in accordance with some embodiments of the invention. Electronic device 100 can include control circuitry 102, storage 104, memory 106, input/output (“I/0”) circuitry 108, and communications circuitry 110. In some embodiments, one or more of the components of electronic device 100 can be combined or omitted (e.g., storage 104 and memory 106 may be combined). In some embodiments, electronic device 100 can include other components not combined or included in those shown in FIG. 1 (e.g., motion detection components, a power supply such as a battery or kinetics, a display, bus, a positioning system, a camera, an input mechanism, etc.), or several instances of the components shown in FIG. 1. For the sake of simplicity, only one of each of the components is shown in FIG. 1.

Electronic device 100 can include any suitable type of electronic device. For example, electronic device 100 can include a portable electronic device that the user may hold in his or her hand, such as a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface.

Storage 104 can include, for example, one or more storage mediums including a hard-drive, solid state drive, flash memory, permanent memory such as ROM, any other suitable type of storage component, or any combination thereof. Storage 104 can store, for example, media data (e.g., music and video files), application data (e.g., for implementing functions on electronic device 100), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM, and/or one or more different types of memory used for temporarily storing data. In some embodiments, memory 106 can also be used for storing data used to operate electronic device applications, or any other type of data that can be stored in storage 104. In some embodiments, memory 106 and storage 104 can be combined as a single storage medium.

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (CODEC) to convert digital media data into analog signals. For example, the display circuitry (or other appropriate circuitry within electronic device 100) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled a host device for data transfers, synching the communications device, software or firmware updates, providing performance information to a remote source (e.g., providing riding characteristics to a remove server) or performing any other suitable operation that can require electronic device 100 to be coupled to a host device. Several electronic devices 100 can be coupled to a single host device using the host device as a server. Alternatively or additionally, electronic device 100 can be coupled to several host devices (e.g., for each of the plurality of the host devices to serve as a backup for data stored in electronic device 100).

In some embodiments, an electronic device (e.g., electronic device 100 of FIG. 1) may include an integrated application operative to interface with a fashion provider system to provide access to different fashion items and services made available by the fashion provider. As used herein, the term “fashion provider” can refer to a merchant, a shop (e.g., a physical store, an on-line store, or both), or to any other entity suitable for providing fashion items to a user. The fashion items can include, for example, clothing (e.g., shirts, pants, jackets, socks, or other clothing), accessories (e.g., watches, hats, purses, jewelry, or other accessories), footwear, or other suitable item that a person may wear or carry.

In some embodiments, a single, integrated application of the electronic device can be used to provide the access to the different services and fashion items of a fashion provider. For example, the single, integrated application can allow the fashion provider to attract customers by sending promotions directly to a user, can provide a store locator so a user can easily locate the fashion provider, or otherwise can attract a user to the fashion provider. As another example, the integrated application can provide a user with enhanced information regarding the fashion items of a fashion provider by allowing a user to monitor trends of fashion items, scan a tag of a fashion item with the user's electronic device to access additional information regarding the fashion item, and the like. As yet another example, the integrated application can provide a user with in-store sales assistance (e.g., by providing availability information of a desired fashion item) and can provide a user with post-purchase opportunities (e.g., by sending bounceback offers to a customer). In this manner, through an integrated application, a provider can maintain a constant connection between themselves and the user. This can result in changing a user's shopping experience from a fragmented and disjointed process to one that is instead seamless and that provides the user with enhanced access to the fashion provider.

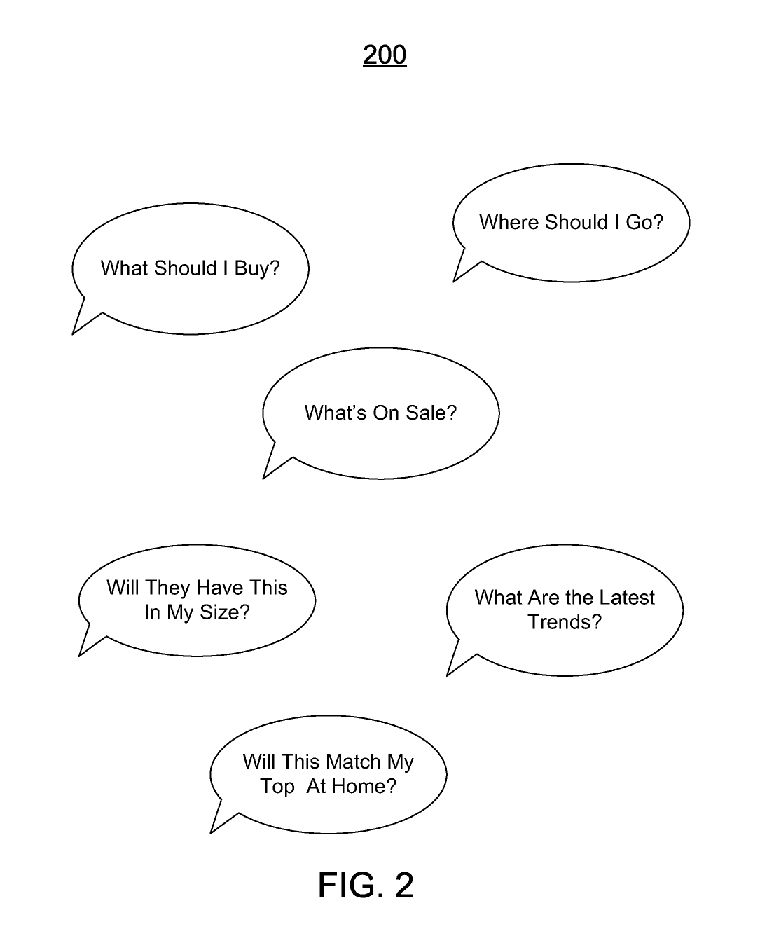

FIG. 2 is a schematic view of several situations during which a user can make use of a single, integrated application in the context of the fashion industry in accordance with some embodiments of the invention. For example, the integrated application could be used to provide recommendations of what to buy and where to buy the recommended items. As another example, the integrated application can aid a user in identifying sales and in determining the availability of specific items. Moreover, through the integrated application, a user can compare new items with the fashion items already owned by the user, and monitor the latest trends to ensure that purchases are as desired. In this manner, by providing a single integrated application having access to information from the fashion provider, the fashion provider can control and enhance the user's experience with the provider's brands.

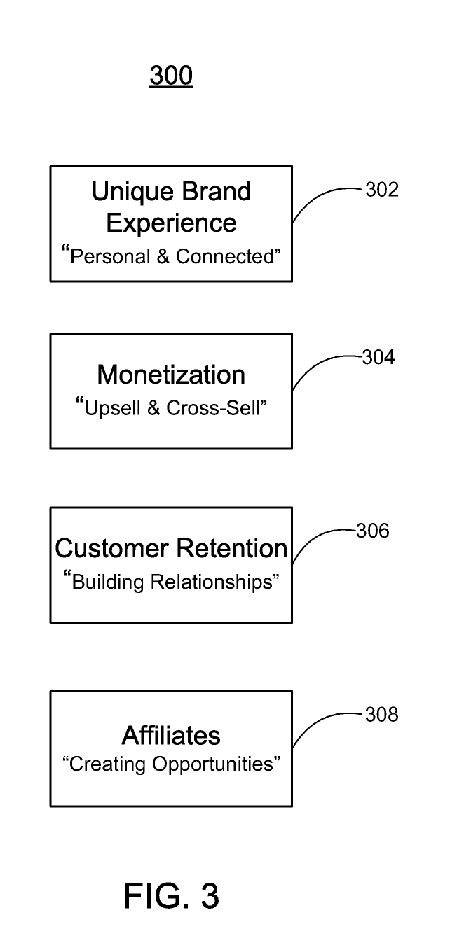

For example, as indicated by diagram 300 of FIG. 3, through the integrated application, the fashion provider can create a unique brand experience 302. For example, the integrated application can create an experience that is personal and connected to a shopper (e.g., by promoting continuity and maintaining contact between a fashion provider and a user based on the user's personal preferences and habits). The integrated application may also enhance a user's experience through monetization 304. For example, up-selling and cross-selling offers may be presented to a user through the integrated application. The integrated application may also allow for customer retention 306. For example, the integrated application can build customer relations and promote customer retention (e.g., by addressing a shopper's needs 24 hours a day and 7 days a week to provide the utmost satisfaction). Yet another advantage of the integrated application can include affiliate opportunities 308. For example, since a portable electronic device's simplicity, affordability, and portability may appeal to a broad scope of shoppers, a broad scope of shoppers may be using the integrated application. Affiliate companies may then be given the opportunity to reach this wide range of shoppers through the integrated application. In this manner, a single, integrated application can control and enhance the user's experience with the fashion provider.

To interface with the fashion provider, the integrated application can use any suitable approach. In some embodiments, the electronic device can securely connect to one or more servers associated with the fashion provider (e.g., through communication circuitry 110 of FIG. 1). For example, the integrated application can connect to servers available from one or more stores or high fashion providers to receive data reflecting their fashion items. The received data can include information such as, for example, fashion item sizes, fashion item colors, fashion item prices, fashion item styles, availability of fashion items, or any other suitable information. As another example, the integrated application can connect to the servers to receive recommendations from fashion providers regarding recommended combinations of fashion items (e.g., to form an outfit). In some embodiments, the integrated application can allow a user to connect to the fashion provider's server through a secure connection to perform transactions (e.g., using a credit card). In this manner, a user may, for example, pay for or reserve a particular fashion item of the fashion provider.

In some embodiments, the integrated application of the electronic device can receive information from fashion providers including metadata associated with fashion items. The metadata can define, for example, attributes of the fashion items such as the type of item (e.g., pants, shirt, jacket, hat, and the like), color, collection, style (e.g., casual, work attire, winter clothing, summer clothing, and the like), price, availability (e.g., number available at a certain store in a certain size, color, style, or the like), or any other suitable characteristic of the fashion items. In some embodiments, in addition to or instead of receiving metadata, the integrated application can identify attributes of merchandise from available images and descriptions of the merchandise. For example, an image of a fashion item can be taken with a camera of the electronic device. The integrated application may then analyze the image to identify attributes of the fashion item.

Using the fashion item attributes (e.g., attributes received through metadata, attributes identified by the integrated application, or both), the integrated application can compare merchandise from different stores, fashion providers, or both. For example, the integrated application can analyze various fashion items and recommend combinations of apparel from different stores or fashion providers to the user. As another example, the integrated application can analyze a fashion item and recommend suitable alternatives to this fashion item (e.g., a similar fashion item that is cheaper in price, a similar fashion item that is a desired brand, and the like).

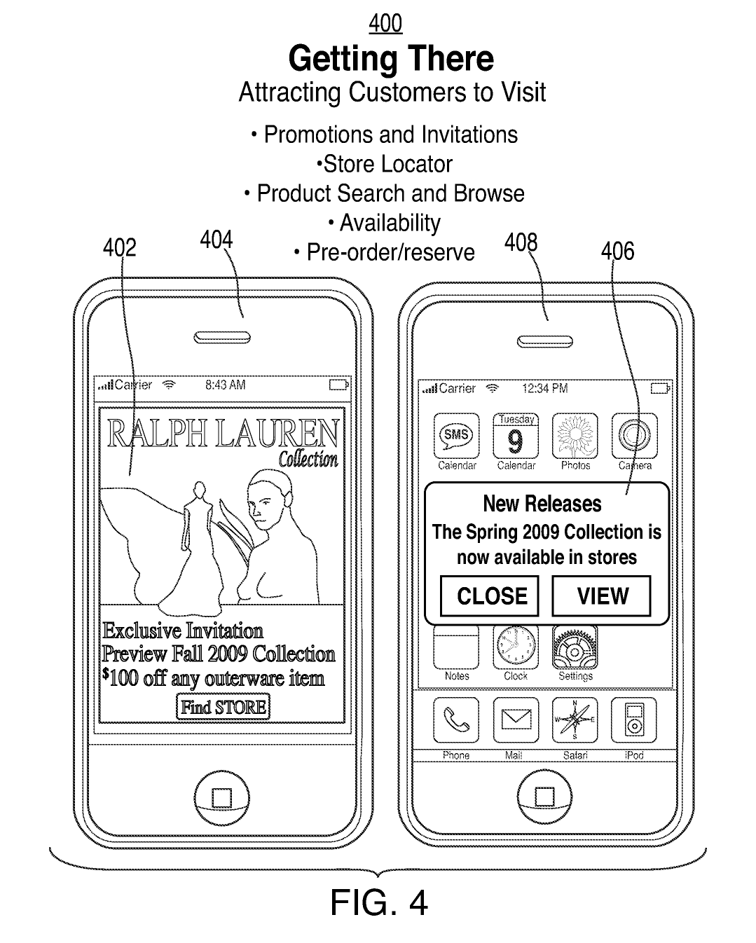

FIG. 4 shows diagram 400 of functions for attracting a user to view a fashion provider in accordance with some embodiments of the invention. For example, the functions of diagram 400 can be used to initially educate a user about a fashion provider, generate user interest in the fashion provider, and otherwise entice a user to visit with and shop at the fashion provider (e.g., physically visit a store of the fashion provider, shop at an on-line site of the fashion provider, or otherwise view the provider's fashion items).

As indicated in diagram 400, the application can provide a user with promotions and invitations to special events. The promotions can include, for example, coupons for on-sale items, time-sensitive sale information (e.g., a sale such as “buy this item within the next two hours to receive 25% off!” to incite buyers to come to stores to take advantage of the limited offers), or any other suitable promotions. The invitations can include general events for a specific subset of customers (e.g., a “friends and family” event), a personalized event for the user himself, alerts of particular fashion items (e.g., a new collection that has arrived, fashion items now on sale, and the like), or any other suitable fashion item. For example, invitation 402 shows an exemplary invitation to “Preview Fall 2009 Collection” that can be provided via an integrated application of electronic device 404. As another example, alert 406 shows an exemplary alert of available fashion items, where alert 406 can be provided to a user through an integrated application of electronic device 408.

The promotions and invitations can be provided to the user in any suitable manner. For example, the promotions and invitations can include an e-mail, a text message, a voicemail, a pop-up message, a push notification (e.g., a notification that utilizes an internet protocol (“IP”) connection to forward notifications from the servers of third party applications to an electronic device), any other suitable notification, or any combination of the above. In some embodiments, a user can specify user preferences to determine what promotions and invitations are received by the integrated application. For example, user preferences can determine that a user desires to receive promotions and invitation associated with a certain fashion provider, a certain style, a certain fashion item size, a certain location, or any other suitable preference. In this manner, a fashion provider can easily and conveniently contact a large group of customers by transmitting promotions and invitations directly to the customers' electronic devices. This may, for example, allow the fashion provider to advertise to customers without needing to keep track of a large number of addresses, phone numbers, e-mail addresses, or other contact information.

As indicated in diagram 400, the integrated application can moreover provide a user with functions such as a store locator, the ability to search and browse products, and the ability to check product availability. For example, the integrated application can access an integrated or accessible mapping application to provide a map, direction, or both to a desired fashion provider. As another example, the integrated application can interface with servers from one or more fashion providers to receive current information as to the availability and price of various fashion items. The integrated application may then provide a menu, a catalog, or other suitable interface on the electronic device. This interface may allow a user to browse the fashion items, search for a particular fashion item, or otherwise view the merchandise of the fashion providers. In response to a user selection of a particular fashion item from interface displayed by the electronic device, the electronic device can determine, from an appropriate source (e.g., from the server of the fashion provider), the nearest stores carrying the fashion item, the prices of the fashion item in each of the stores, the sizes available in each of the stores, any combination of the above, or any other suitable information associated with the selected fashion item.

In some embodiments, a user can pre-order or reserve fashion items of interest. For example, a user may select a fashion item from the interface provided by the integrated application on the electronic device. The user may then choose to pre-order the fashion item and have the fashion item delivered to them (e.g., mailed to their home), or the user may pick up the item at a local store. As another example, a user may reserve the selected item. For example, the user can reserve a desired fashion item in a particular size or color. The user may then come to the fashion provider's store to view the reserved fashion item in-person or to try on the reserved fashion item. Furthermore, since the user may potentially buy additional merchandise from the fashion provider once they are in-store, allowing the user to reserve fashion items can result in generating additional revenue for the fashion provider. In some embodiments, a user can provide payment or credit card information (e.g., through a secure network of the fashion provider) to secure the desired fashion item.

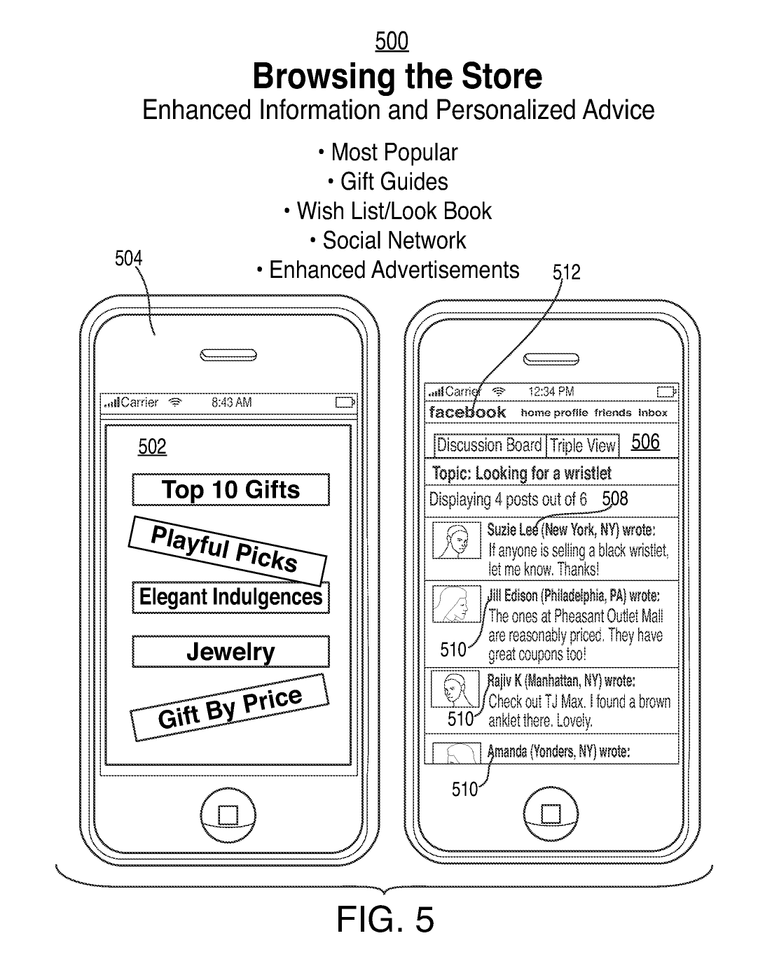

FIG. 5 shows diagram 500 of functions available to a user for browsing a store in accordance with some embodiments of the invention. For example, the functions of diagram 500 can provide a user with enhanced information regarding one or more fashion items of a provider after the user has been attracted to view the fashion provider (e.g., attracted by functions such as those illustrated in FIG. 4).

As shown in diagram 500, a user can receive advice regarding popular items through the integrated application. For example, the integrated application can monitor trends by keeping track of what fashion items people are buying. In this manner, the integrated application can determine what are “hot” fashion items and can provide recommendations of these popular items to the user. For example, interface 502 shows an exemplary interface for providing recommendations of popular items to a user through electronic device 504. In some embodiments, the recommendations can be separated into various categories. For example, as illustrated by interface 502, a user can receive recommendations of fashion items that are currently popular as gift items, as leisure items, as luxury items, as jewelry, that are within a certain price range, or recommendations of fashion items that are within any other suitable category. In some embodiments, the integrated application can allow a user to filter the received recommendations. For example, the recommendations can be filtered based on a desired color, a desired brand, a desired style, a desired price range, a desired type of fashion item, or any other suitable factor.

As shown in diagram 500, the integrated application can provide a user with gift guides, allow a user to generate and update a wish list and a look book, and use social networking features to request and receive feedback from friends or other members of a social network. For example, in some embodiments, a user can create a wish list, a look book, or other collection of desired fashion items. The user may add fashion items to the collection by, for example, selecting the fashion item from a catalogue provided by the integrated application, selecting the fashion item from an on-line site of the fashion provider, taking a picture of the fashion item (e.g., with a camera of the electronic device), taking a screen shot of a fashion item from an on-line site, or by any other suitable manner. In some embodiments, when a fashion item is added to a user's catalogue, the integrated application can determine suitable attributes of the fashion item (e.g., color, type, brand, season, style, or other attributes). For example, the attributes can be determined by receiving metadata associated with the attributes from a server of the fashion provider, by analyzing a digital image of the fashion item, and the like.

To provide for social networking features, the user catalogue may be accessible by a social website such as an on-line blog (e.g., Xanga), a news-feed, a personal news-feed (e.g., Twitter), a social networking site (e.g., Facebook, Linkedin, MySpace), or any other suitable social website. Acquaintances, friends, or other members of the social website may then access the user's collection to view the collection, provide feedback on the collection (e.g., comment on fashion items they like or dislike, rate fashion items, or provide other suitable feedback), provide recommendations (e.g., recommend fashion items to complete an outfit), and the like. For example, interface 506 shows an exemplary interface for allowing user 508 to receive comments, advice, recommendations, and other feedback from members 510 of social network 512.

In some embodiments, rather than adding an entire collection to the social website, a user may alternatively or additionally add a single fashion item to the social website. As an illustration, a user may see a fashion item in a store which interests them. The user may then take an image of the fashion item, and upload this image to the social website, thus allowing friends to provide feedback and comments on the fashion item. In some embodiments, the collection, single fashion item, or both can be posted to a kiosk or other public viewing area. Systems and methods for providing such a kiosk are described in more detail in the Patent Application entitled, “Social Networking in Shopping Environments,” patent application Ser. No. 12/493,961 and attorney docket number P7946US1, filed on Jun. 29, 2009, which is hereby incorporated by reference in its entirety.

As is also indicated by diagram 500, the integrated application can provide fashion item information to a user through enhanced advertisements. For example, an advertisement for a fashion item can be provided through any suitable medium such as an advertisement in a magazine, an advertisement in a newspaper, an advertisement on a bus stop, an advertisement on a poster, an advertisement on a website, or any other suitable medium. The enhanced advertisement can include a barcode or other optical pattern associated with the fashion item. The integrated application may then read and analyze the optical pattern by, for example, taking a picture of the barcode (e.g., with a camera of the electronic device) to determine additional, enhanced information associated with the fashion item. For example, the enhanced information can include information such as stores in which the fashion item is currently available, sizes in which the fashion item is currently available, colors in which the fashion item is currently available, price, style, brand, fashion provider, ratings, recommended fashion items to complete an outfit, or other suitable information. The optical pattern can, for example, directly include the enhanced information or can include a serial number or other identifying information allowing the integrated application to access a remote database of associated fashion item information.

In some embodiments, rather than including a barcode or other apparent optical pattern, the enhanced advertisement can include an embedded pixel pattern. The embedded pixel pattern can operate similar to a barcode, but may be hidden within the advertisement such that the pattern is not visually apparent to the general public. In this scenario, to receive enhanced information related to a fashion item, a user can simply take a picture of the advertisement with an electronic device. The integrated application may then identify the embedded pixel pattern within the advertisement, and access enhanced information associated with the fashion item of the advertisement based on the embedded pixel pattern. In this manner, enhanced information can be provided to a user without requiring barcodes or other visual pattern which may potentially be distracting or unsightly to the advertisement.

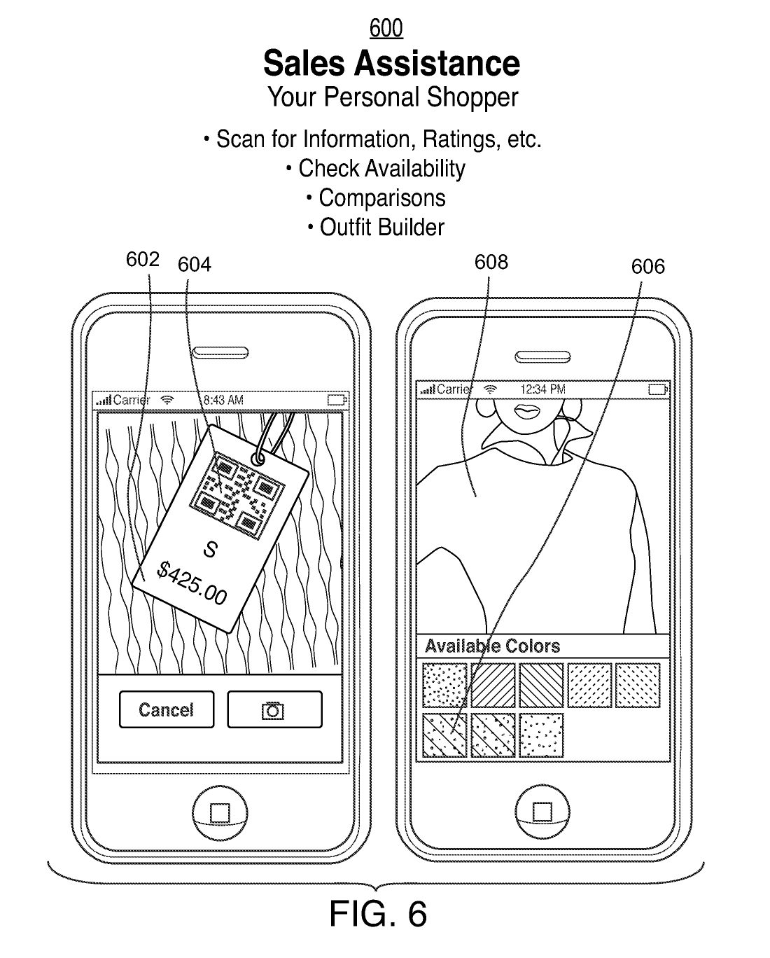

FIG. 6 shows diagram 600 of in-store sales assistance functions available to a user in accordance with some embodiments of the invention. As an illustration, a user may have been encouraged to visit a fashion provider's store through the functions of FIGS. 4 and 5, respectively, thus providing an opportunity for the integrated application to provide the in-store functions of diagram 600. Through the functions of diagram 600, the integrated application can deliver a wide variety of information regarding in-store fashion items directly to the user. In this manner, the user's electronic device can function as the user's own personal sales assistant, and can provide for a convenient, fast, and efficient way of delivering fashion item information to the user.

As shown in diagram 600, a user can scan a fashion item to determine information, determine ratings, and check availability for that fashion item (e.g., check availability in one or more sizes, in one or more colors, in one or more styles, or the like). The information, ratings, and availability can be specific to the store in which the user is located, or can include information from other locations of the store. To “scan” the fashion item, the fashion item can include a price tag or other identifying tag including an optical pattern (e.g., a barcode). For example, price tag 602 shows an exemplary optical pattern 604 in accordance with some embodiments. The optical pattern may then be scanned or read by the integrated application (e.g., by taking a digital image of the optical pattern with a camera of the electronic device) to access information, ratings, and availability of the fashion item. For example, interface 606 shows an exemplary interface that can be generated by an integrated application to provide information associated with fashion item 608 by scanning optical pattern 604 of its price tag.

As is indicated in diagram 600, a user can compare fashion items through the integrated application. For example, when a user selects a particular fashion item (e.g., by scanning a optical pattern of the fashion item's price tag), the integrated application can determine nearby stores carrying the same or a similar fashion item and the prices of the fashion item in each of the stores. To determine this information, the integrated application may, for example, identify the available merchandise in other locations of the same fashion provider, identify the available merchandise of other fashion providers (e.g., to determine similar fashion items), or both.

In some embodiments, as indicated by diagram 600, a user can build outfits by combining fashion items available from the current store, from other locations of the current store, from different fashion providers, or any combination of the above. For example, using an electronic device, a user can scan a fashion item of interest at a fashion provider's store (e.g., by taking a picture of an optical pattern on the price tag of the fashion item). The integrated application may access a database of available fashion items (e.g., fashion items available at the current store, fashion items available at other store locations, fashion items available by other fashion providers, or any combination of the above) to identify fashion items that can be combined with the fashion item of interest to build a suitable outfit. For example, the integrated application can include one or more algorithms operative to generate and recommend these suitable outfit outfits. The recommended outfits may then be provided to the user (e.g., by displaying the recommended outfits on the display of the user's electronic device)

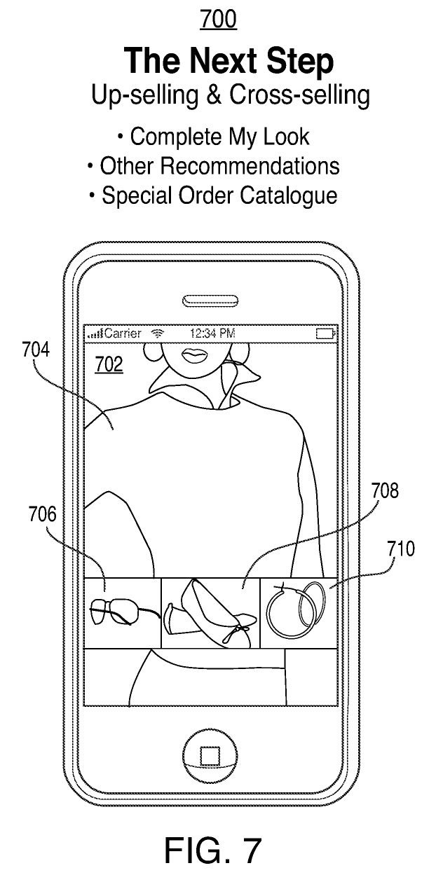

FIG. 7 shows diagram 700 of functions available to a user for up-selling and cross-selling in accordance with some embodiments of the invention. As shown in display 700, the application can provide recommended items to purchase to complete an existing look (e.g., a look from a fashion magazine) or outfit. For example, to further assist a user in designing outfits that include both items already owned by the user and new merchandise available for purchase from fashion providers, the electronic device can include or access a database (e.g., storage 104 of FIG. 1) storing information reflecting the fashion items currently owned by the user (e.g., access a “My Closet” application for viewing, storing, and modifying fashion items already owned by the user). The user can initially populate the My Closet database of owned fashion items by, for example, taking images of the fashion items, finding the fashion items from historical databases of fashion providers (e.g., from an on-line website of a fashion provider), or by entering identifying information or attributes for each fashion item. In some embodiments, the integrated application can automatically update the database by including fashion items into the database as they are purchased by the user (e.g., as determined from a communication between the fashion providers and the electronic device, or from a payment source used to purchase the fashion items and the electronic device).

Based on the My Closet database, the integrated application may provide recommendations of fashion items to purchase so the user may build an outfit. For example, the integrated application can include one or more algorithms operative to build these outfits by combining fashion items from the My Closet database with one or more fashion items available for purchase. For example, interface 702 shows an exemplary interface for providing fashion item recommendations to a user for building an outfit including fashion item 704. Fashion item 704 may, for example, include a fashion item already owned by the user and included in a My Closet database. The integrated application may search fashion items available for purchase from one or more fashion providers (e.g., by accessing a database of fashion items of the fashion provider) and determine which available fashion items would match or suitably build an outfit with fashion item 704. These matching fashion items may then be recommended to the user for purchasing. For example, as illustrated by interface 702, fashion items such as fashion items 706, 708, and 710 can be recommend to the user for building an outfit with 704. In some embodiments, the user can purchase the recommended fashion items (e.g., fashion items 706, 708, and 710) through interface 702 (e.g., by transmitting credit card or other payment information to the fashion provider through a secure server).

As shown in diagram 700, the integrated application may moreover provide other recommendations and provide access to a special order catalog. For example, through the special order catalog, a user can be provided with an opportunity to order otherwise unavailable fashion items.

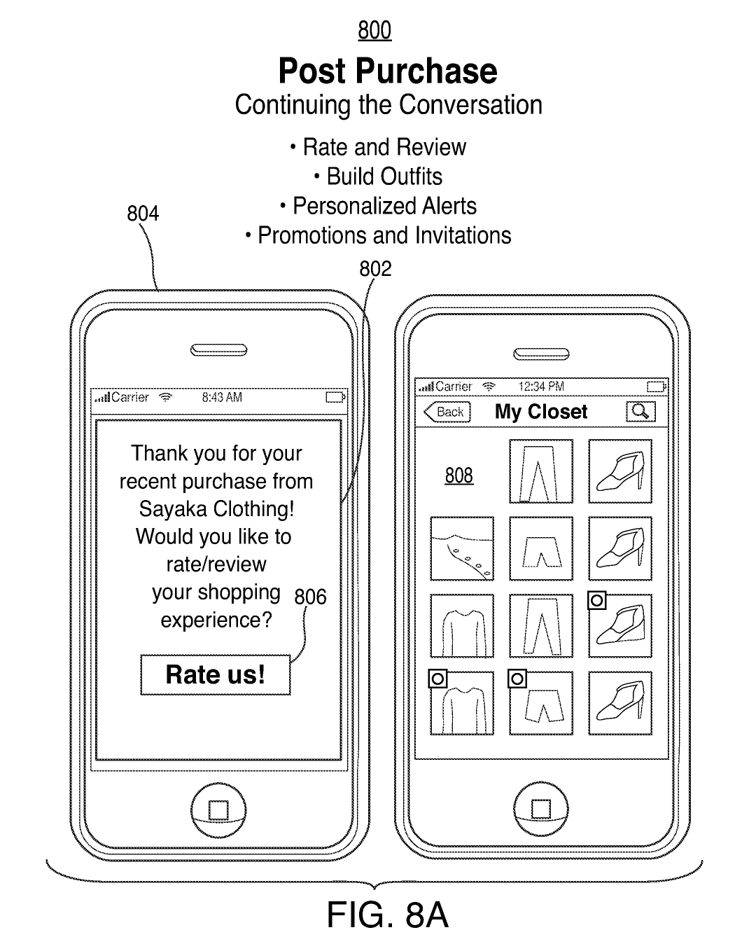

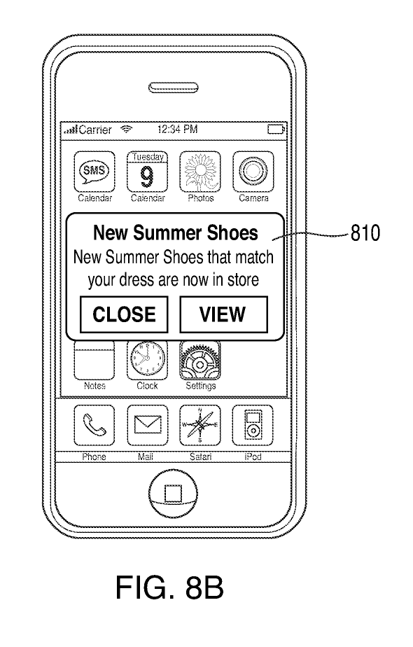

FIGS. 8A and 8B show functions available to a user after purchasing a fashion item in accordance with some embodiments of the invention. For example, the functions of diagram 800 can provide a user with follow-up information and offers associated with a fashion item the user has purchased or viewed, associated with a fashion provider the user has visited or from whom the user has purchased a fashion item, or any combination of the above.

As shown in display 800 of FIG. 8A, the user can rate and review stores, fashion providers, fashion items, or any combination of the above after purchasing a fashion item or visiting a fashion provider. In some embodiments, the integrated application can provide an opportunity directly to a user's electronic device for leaving ratings. For example, notification 802 shows an exemplary way of providing a user with an opportunity for leaving a rating or review through electronic device 804. Notification 802 can be provided in any suitable manner and can include any suitable notification such as, for example, an e-mail, a text message, a voicemail, a pop-up message, a push notification (e.g., a notification that utilizes an internet protocol (“IP”) connection to forward notifications from the servers of third party applications to an electronic device), any other suitable notification, or any combination of the above. To leave a rating or review, a user may, for example, select a suitable option such as option 806.

As is also indicated in diagram 800, the integrated application can allow a user to build outfits using newly purchased fashion items. For example, as mentioned above, the integrated application can access a My Closet database storing information reflecting the fashion items currently owned by the user. The integrated application may then provide an interface allowing the user to view their currently owned fashion items and build outfits by combing their currently owned fashion items. For example, interface 808 shows an exemplary interface for allowing a user to access a My Closet application and build outfits from currently owned fashion items. Alternatively or additionally, the user can build outfits including fashion items not currently owned (e.g. that are available for purchase from a fashion provider), items currently owned, or both.

Furthermore, as indicated by diagram 800, the integrated application can provide a user with notifications such as personalized alerts, promotions, and invitations that are personalized based on the user's past purchases. For example, using historical data to identify buying trends of a particular user, fashion providers can deliver personalized notifications directly to the user's electronic device. In some embodiments, these notifications can include alerts and promotions for fashion items deemed to be of interest to the user based on previous purchases, fashion items completing or creating a new outfit, fashion items of a particular type identified as needed by the user (e.g., automatically determined based on the fashion items currently owned by the user, defined by the user, or both). For example, FIG. 8B shows exemplary notification 810 for informing a user that a fashion item which may interest the user is now available. In some embodiments, the notifications can recommend a fashion item needed for a special occasion, where information associated with the special occasion can be retrieved from a user's calendar (e.g., a calendar application integrated into or accessible by the integrated application). For example, the integrated application can recommend a dress for attending a wedding that is scheduled in the next month in the user's calendar.

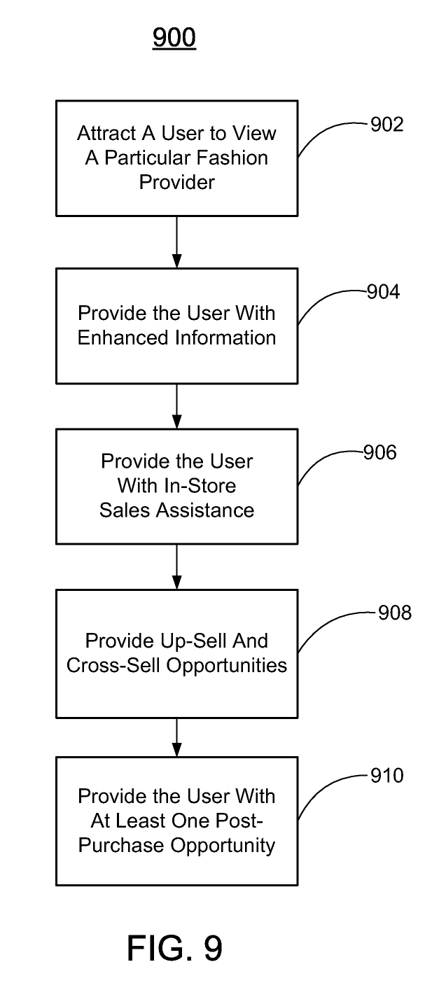

Accordingly, in some embodiments, an integrated application can be used to provide a complete fashion experience to a user through an integrated application of an electronic device. FIG. 9 shows illustrative process 900 for providing a complete fashion experience to a user.

At step 902, functions can be provided to attract a user to view a particular fashion provider. For example, promotions and invitations associated with the particular fashion provider can be received by the user's electronic device. As another example, an interface operative to show availability information, pricing information, and other information related to the fashion items of the fashion provider can be provided on the user's electronic device. As another example, functions such as a store locator application can be provided. In some embodiments, the user can be provided with an opportunity to pre-order a fashion item, reserve a fashion item (e.g., for later viewing at a store of the fashion provider), or both through the user's electronic device.

At step 904, functions can be provided to allow a user to browse the particular fashion provider and receive enhanced information associated with at least one fashion item of the fashion provider (e.g., once the user has been attracted to view the particular fashion provider). For example, enhanced advertisements for a fashion item can be provided which a user may scan with their electronic device (e.g., by taking a digital image of the advertisement with a camera of the electronic device). The enhanced advertisement can include an optical pattern (e.g., a barcode), an embedded pixel (e.g., a pattern which may not be visually apparent to the general viewer), or both including information associated with the fashion item. By scanning the enhanced advertisement, the electronic device may access and provide additional information associated with the fashion item (e.g., price, availability, ratings, style, color, brand, and the like) directly to the user's electronic device. As another example, an application allowing a user to view, create, modify, and share wish lists, look books, and gift guides can be provided. As another example, social networking features can be provided allowing a user share fashion item and fashion provider information with a social network and receive back feed from the members of the social network. As yet another example, the electronic device can monitor buying trends to determine what fashion items are currently popular, and provide recommendations of these popular fashion items to the user.

At step 906, functions for providing in-store sales assistance can be accessible through the electronic device (e.g., the electronic device can function as a personal and readily accessible sales assistant once the user has arrived at the fashion provider's store). For example, price tags of fashion items in the store can include an optical pattern (e.g., a barcode). A user can scan the optical pattern to access additional functions and information associated with that fashion item (e.g., by taking a digital image of the optical pattern with a camera of the electronic device). For example, the electronic device can read identifying information associated with the fashion item from the optical pattern, and use this identifying information to access product availability information such as price, style, color, sizes, ratings and the like in this store or in other store locations of the fashion provider (e.g., by accessing a database of fashion item identifying information and their associated product availability information). A menu showing the product availability information can be generated and displayed on the user's electronic device. As another example, based on the identifying information of the optical pattern, the electronic device can compare the fashion item to the same or similar fashion items in nearby stores and provide these comparisons (e.g., price, availability, and the like) to the user. AS another example, the electronic device can provide an interface allowing the user to build outfits with the scanned fashion item (e.g., using other fashion items in the store, fashion items currently owned by the user, fashion items available by other fashion provider, or any other suitable fashion items).

At step 908, up-sell and cross-sell opportunities can be provided to the user. For example, the electronic device may include or access a database of fashion items currently owned by the user. Based on the database, the integrated application may locate fashion items available for purchase from one or more fashion providers (e.g., by accessing a database of fashion items of the fashion provider) that can be matched with the user's currently owned fashion items to produce a suitable outfit. These matching fashion items may then be recommended to the user for purchasing. As another example, a special order catalog can be accessed through the electronic device to provide the user with an opportunity to order otherwise unavailable fashion items.

At step 910, at least one post-purchase opportunity can be provided to the user. For example, the user can be provided with an opportunity to rate and review a fashion provider, a store, a fashion item, or any combination of the above. As another example, a user can be provided with follow-up promotions, personalized alerts, and invitations that are personalized based on the user's past purchases. For example, using historical data to identify buying trends of a particular user, personalized notifications associated with these buying trends can be identified and provided to the user through their electronic device.

The process discussed above is intended to be illustrative and not limiting. Persons skilled in the art could appreciate that steps of the process discussed herein can be omitted, modified, combined, or rearranged, and any additional steps can be performed without departing from the scope of the invention.

The inventions can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer-readable medium can also be distributed over network coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

The above-described embodiments of the present invention are presented for purposes of illustration and not of limitation.

What is claimed is:

1. A method for interfacing with a fashion provider, comprising providing a complete fashion experience, the method comprising:
attracting a user, via an integrated application of a portable electronic device, to view products for sale from a particular fashion provider;
providing the user with enhanced information associated with at least one fashion item of the particular fashion provider through the integrated application;
providing the user with in-store sales assistance at a store of the particular fashion provider through the integrated application; and
providing the user with at least one post-purchase opportunity associated with the particular fashion provider through the integrated application.

2. The method of claim 1, wherein attracting the user comprises:
transmitting at least one promotion associated with the particular fashion provider to the portable electronic device.

3. The method of claim 2, wherein attracting the user further comprises:
receiving at least one user preference of the user;
comparing the at least one user preference to a listing of promotions to identify at least one matching promotion of the listing; and
transmitting the at least one matching promotion to the portable electronic device.

4. The method of claim 2, wherein the promotion comprises at least one of an e-mail, a text message, a voicemail, a pop-up notification, and a push notification.

5. The method of claim 1, wherein attracting the user comprises:
providing a catalog of available fashion items of the particular fashion provider and associated fashion item information to the user through the integrated application.

6. The method of claim 1, wherein providing the user with enhanced information comprises:
monitoring current buying trends to determine at least one popular item; and
providing a recommendation to purchase the at least one popular item to the user through the integrated application.

7. The method of claim 1, wherein providing the user with in-store sales assistance comprises:
identifying fashion items owned by a user;
identifying an outfit of interest to the user, wherein at least a portion of the outfit includes one of the identified fashion items;
determining a new fashion item available for purchase at the store for use as part of the identified outfit; and
receiving an instruction to purchase the new fashion item.

8. The method of claim 1, wherein providing the user with at least one post-purchase opportunity comprises:
updating a database of fashion items owned by the user in response to the user purchasing a fashion item from the particular fashion provider.

9. The method of claim 8, wherein providing the user with at least one post-purchase opportunity further comprises:
matching the fashion items of the database to a listing of new fashion items available for purchase to determine at least one new fashion item suitable for creating an outfit with at least one fashion item of the database; and
providing a recommendation to purchase the at least one new fashion item to the user through the integrated application.

10. The method of claim 1, wherein providing the user with at least one post-purchase opportunity comprises:
transmitting at least one bounceback offer to the user through the integrated application.

11. The method of claim 10, wherein providing the user with at least one post-purchase opportunity further comprises:
analyzing at least one past-purchase of a fashion item by the user to determine user-preferred fashion items; and
transmitting the at least one bounceback offer to the user through the integrated application, wherein the at least one bounceback offer is associated with the user-preferred fashion item.

12. The method of claim 1, wherein providing the user with at least one post-purchase opportunity comprises:
determining new fashion items of the particular fashion provider are now available; and
transmitting a listing of the new fashion items to the user through the integrated application, wherein the listing comprises an option to purchase at least one of the new fashion items.

13. The method of claim 1, wherein providing the user with at least one post-purchase opportunity comprises:
providing the user with an opportunity to rate at least one of the particular fashion provider, the store, and a fashion item purchased from the particular fashion provider.

14. An electronic device for interfacing with a fashion provider, the electronic device comprising:
a processor operable to run an integrated application providing functions to:
attract a user to view a particular fashion provider;
provide enhanced information associated with the particular fashion provider to the user; and
provide the user with in-store sales assistance at a store of the particular fashion provider;
a camera operable to capture a digital image of at least one fashion item of interest; and
communication circuitry operable to transmit the image to a social network for providing social networking features associated with the at least one fashion item of interest.

15. The electronic device of claim 14, wherein the electronic device comprises a portable electronic device.

16. The electronic device of claim 14, wherein the processor is further operable to:
identify the fashion item of interest from the digital image; and
add the identified fashion item to a wish list of the user.

17. The electronic device of claim 14, wherein the social networking features comprise providing an option for members of the social network to provide feedback on the fashion item of interest.

18. The electronic device of claim 14, further comprising:
a display component, and wherein:
the processor is further operable to:
generate a store locator comprising a map and directions to the particular fashion provider; and
direct the display component to display the store locator.

19. The electronic device of claim 14, wherein:
the camera is further operable to capture a digital image of an enhanced advertisement, wherein the enhanced advertisement is associated with a particular fashion item; and
the processor is further operable to:
identify a particular optical pattern of the enhanced advertisement within the digital image;
identify enhanced information of the particular fashion item, wherein the enhanced information is associated with the particular optical pattern; and
provide the enhanced information to the user.

20. The electronic device of claim 19, wherein the particular optical pattern comprises an embedded pixel pattern.

21. The electronic device of claim 19, wherein the enhanced information comprises at least one of availability, price, style, color, brand, fashion provider, and ratings of the particular fashion item.

22. The electronic device of claim 14, wherein:
the camera is further operable to capture a digital image of a price tag of a particular fashion item; and
the processor is further operable to:
identify a barcode within the digital image;
identify enhanced information of the particular fashion item, wherein the enhanced information is associated with the barcode; and
provide the enhanced information to the user.

23. Machine-readable media for interfacing with a fashion provider, the machine-readable media comprising machine-readable instructions recorded thereon for:
attracting a user, via an integrated application of a portable electronic device, to view products for sale from a particular fashion provider;
providing the user with enhanced information associated with at least one fashion item of the particular fashion provider through the integrated application;
providing the user with in-store sales assistance at a store of the particular fashion provider through the integrated application; and
providing the user with at least one post-purchase opportunity associated with the particular fashion provider through the integrated application.
